(19) United States
(12) Patent Application Publication
(10) Pub. No.: US 2025/0393011 A1
(43) Pub. Date: Dec. 25, 2025

(54) ROUTING REQUESTS TO MACHINE LEARNED MODELS

(71) Applicant: T-Mobile USA, Inc., Bellevue, WA (US)

(72) Inventors: Ming Shan Kwok, Seattle, WA (US); Thomas P. Lucht, Seattle, WA (US); John Saw, Kirkland, WA (US)

(21) Appl. No.: 18/750,947

(22) Filed: Jun. 21, 2024

(51) Int. Cl. H04W 64/00; H04W 8/22; H04W 24/02

(52) U.S. Cl. CPC H04W 64/00; H04W 8/22; H04W 24/02

(57) ABSTRACT

Techniques for routing input(s) associated with a machine learned model to various models located at different locations are discussed herein. In some examples, the model may be a generative machine learned model, and in some examples, the different locations may correspond to a first location on a user equipment (UE), a second location in a core network of a network provider, and/or a third location outside of the core network. In some examples, a routing component on the UE may receive an input to a machine learned model and can determine characteristics of the input, and/or characteristics and/or capabilities of the UE, and can route the input to the one or more of the first location, the second location, the third location, or other locations. The UE can receive a response from the location and can present the response at the UE.

### BACKGROUND

Cellular communication devices use network radio access technologies to communicate wirelessly with geographically distributed cellular base stations. Long-Term Evolution (LTE) is an example of a widely implemented radio access technology that is used in 4^{th} Generation (4G) communication systems. New Radio (NR) is a newer radio access technology that is used in 5^{th} Generation (Fifth Generation, or 5G) communication systems. Standards for LTE and NR radio access technologies have been developed by the 3rd Generation Partnership Project (3GPP) for use by wireless communication carriers.

Cellular communication devices may use machine learned models to perform a variety of tasks, such as classification, text generation, image generation, and the like. In some examples, a machine learned model may be implemented on a device and in some examples a machine learned model may be implemented remotely from the device, and the device may send input to the model and may receive a response.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example environment including a user equipment with a routing component to route input(s) associated with a machine learned model to various models located at different locations in a network.

FIG. 2 is a block diagram of a routing component configured to route an input to various locations based on input characteristics and device capabilities.

FIG. 3 illustrates an example computing device to implement the routing component for routing inputs to machine learned model(s), as discussed herein.

FIG. 4 illustrates an example process for routing an input to various machine learned models implemented at different locations.

FIG. 5 illustrates an example process for routing an input to various machine learned models in parallel, as discussed herein.

### DETAILED DESCRIPTION

Described herein are techniques for routing input(s) associated with a machine learned model to various models located at different locations. In some examples, the model may be a generative machine learned model, and in some examples, the different locations may correspond to a first location on a user equipment (UE), a second location in a core network of a network provider, and/or a third location outside of the core network. In some examples, a routing component on the UE may receive an input to a machine learned model and can determine characteristics of the input, and/or characteristics and/or capabilities of the UE, and can route the input to the one or more of the first location, the second location, the third location, or other locations. The UE can receive a response from the location and can present the response at the UE.

In some examples, the input can be received at a user equipment. In some examples, the input can be a textual input, an image input, an audio input, a gesture input, and the like. In some examples, the UE can convert the input to another format, such as converting audio data to text data for input to model. In some examples, the input can comprise a plurality of modalities (e.g., combinations of two or more of text, image, audio, gesture, and the like).

In some examples, a machine learned model can be a generative model, such as a large language model, a latent diffusion model, a deep generative artificial neural network, and the like. In some examples, the generative model can be trained to receive an input and output one or more of text, images, and/or audio data in response to the input. In some examples, the output can be a combination of data that is statistically the most relevant response to an input received by the respective model.

In some examples, the UE can comprise a routing component that can receive an input that is intended to be input to a machine learned model, such as a generative model. In some examples, the routing component can be rules-based, heuristic based, and/or can be a machine learned model trained to determine a destination for the input based on a variety of factors. In some examples, the variety of factors can include, but is not limited to, one or more of characteristics of the input and/or characteristics and/or capabilities of the UE or other nodes of network(s). In some examples, the characteristics of the input can include, but are not limited to, one or more of a location preference, a privacy metric, an accuracy metric, an application type, and/or a latency metric. In some examples, characteristics and/or capabilities of the UE can include, but are not limited to, one or more of an indication or whether the UE includes a parallel processing unit (e.g., a graphics processing unit (GPU), an Artificial Intelligence (AI) accelerator, a deep learning processor, or a neural processing unit (NPU)) configured to host a machine learned model.

By way of example, and without limitation, the routing component can receive a textual input to an application operating on the UE. The routing component can determine the application type and/or characteristics of the input based on settings associated with the application and/or characteristics of the content of the text. For example, the routing component can include a machine learned model to determine a probability that the input and/or a response to the input includes personal or private information. In some examples, the routing component can determine (e.g., based on a learned model) where to route the input based on explicit or implicit previous training of the model. The routing component can also determine whether the UE comprises a GPU, whether the UE is associated with a core network (e.g., whether the UE is a subscriber to the network supported by the core network), whether the UE includes a wireless connection with a core network, the latency and/or bandwidth associated with the connection, and the like. The routing component can send the input to one or more models (e.g., in serial or in parallel) and can wait to receive a response from the respective model associated with the location. When the UE receives a response from the model, the UE can present the response (e.g., text, image(s), and/or audio) on an output device associated with the UE (e.g., a display coupled to the UE or a display communicatively coupled with the UE but remote from the UE).

As noted above, in some examples, the routing component can route, select, or otherwise send an input to one or more destinations or locations associated with different instances of a machine learned model. In some examples, a first location may indicate a first machine learned model hosted by or executing on a UE (e.g., on a GPU of the UE). In some examples, a second location may indicate a network node within a core network of a wireless communication provider. In some examples, a third location may indicate a network node outside of or external to the core network mentioned above. That is, in some examples the second location may be within a core network such that a model hosted at or executed at the second location may be on a computing device controlled by a wireless communication provider. In some examples, the third location may be external to the core network (e.g., accessible via the internet).

In some examples, a first model may be hosted at the first location (e.g., on the UE), a second model may be hosted in a core network, and a third model may be hosted outside of the core network. In some examples, the first model, the second model, and/or the third model may be a same model (e.g., a same version of the model such that there is no or substantially no difference in outputs when a same input is provided to the first, second, and third models). In some examples, the first model, the second model, and/or the third model may be different versions of the same model such that a same input provided to each model may result in slightly different outputs. In some examples, the first model executing on the UE may be a smaller model (e.g., the model may comprise fewer parameters) such that the first model may consume less processing resources and/or memory resources when executing an input relative to the second model and/or the third model. As can be understood, the second and/or the third models may be larger models such that there are more parameters associated with the model such that more processing resources are consumed and/or more memory resources are consumed relative to applying the same input to the first model. In some examples, the routing component can determine where to route the input to the model to optimize accuracy, latency, bandwidth, power consumption, privacy, and the like.

In some examples, the UE can be associated with a user profile provided by a wireless communication provider, and in some examples, the second location in the core network be associated with a private network hosted by the wireless communication provider. In some examples, the second location can represent a location within a core network managed by the wireless communication provider. In some examples, access to the second location can be limited/restricted and can provide relatively higher levels of data privacy relative to a similar model hosted at a third location outside the core network. In some examples, capacity at the second location can be managed to provide a threshold amount of bandwidth or processing or memory available for calls to the machine learned model at the second location.

In some examples, the routing component can send an input to a machine learned model hosted in a core network with an instruction to restrict or otherwise prevent a machine learned model hosted outside the core network from operating on the input. In this manner, the routing component can exercise more control over the destination where a model is ultimately executed and can maintain user privacy, data security, and the like.

In some examples, the routing component can determine to send an input to a machine learned model to a first location on the UE and can also determine to send the input to a second location and/or a third location in parallel. In some examples, a first model operating at a first location may have less accuracy than a second model operating at the second location or the third location. However, the first model may have lower latency than the second model. In such a case, the routing component may send the input to the first model and a second model in parallel. The first model may return a result first and the routing component may receive a response from the second model after the result is received from the first model. The UE can present the result on the UE and then update the response with the response from the second model. For example, the routing component can reconcile responses received from the first location, the second location, and/or the third location (or other locations) and presented the updated/harmonized/reconciled response on the UE. In this manner, the techniques can balance accuracy and timeliness of models to provide results quickly to a user and then to update if additional information is received after the first results are presented.

The systems, devices, and techniques described herein can improve the functioning of a device (e.g., a user equipment) by routing request to a machine learned model based on characteristics of the input and the device. For example, the techniques discussed herein can improve network security by preventing or minimizing exposure of private data to network nodes other than those controlled by known entities. Further, techniques discussed herein can balance accuracy and timeliness when selecting between destinations for routing an input for a machine learned model. In some examples, the techniques can conserve and/or preserve battery power on device (on a UE) by routing request(s) to remote network nodes, and in some examples, if a network bandwidth or latency is low, the techniques can ensure that a response is provided by executing a model on a device. The techniques may further improve a functioning of a network by reducing initiation of communications where network resources are not available (and/or when a connection has failed), which may reduce signaling and associated congestion. These and other improvements to the functioning of a computer and network are discussed herein.

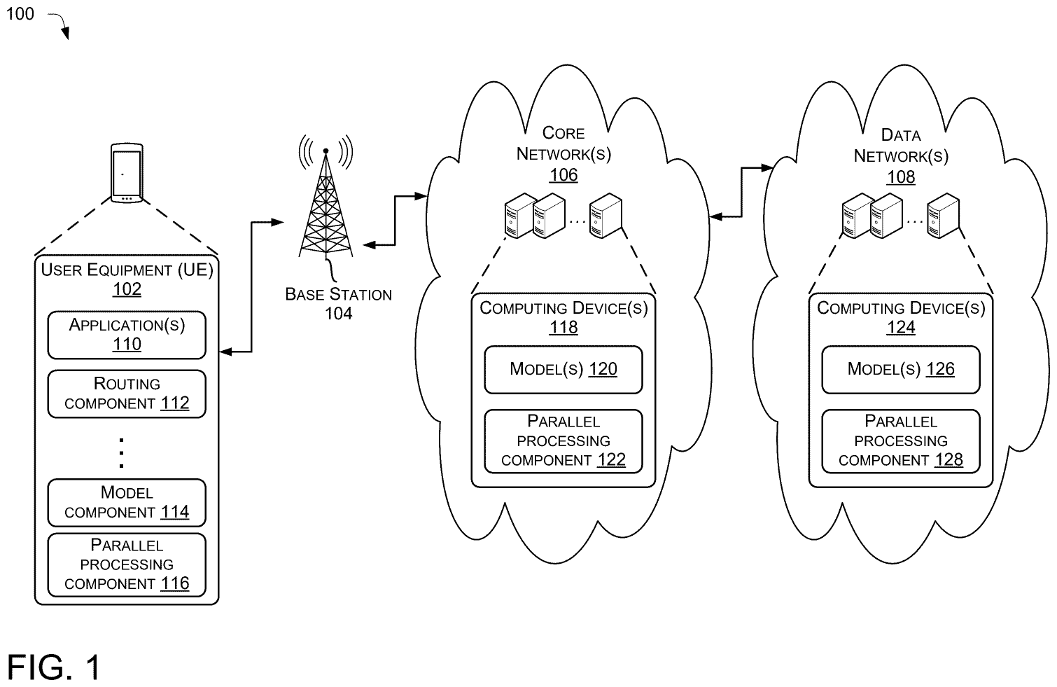

FIG. 1 illustrates an example environment 100 including a user equipment with a routing component to route input(s) associated with a machine learned model to various models located at different locations in a network.

As illustrated, the environment 100 includes a user equipment (UE) 102 communicatively coupled with a base station 104, core network(s) 106, and data network(s) 108. The UE 102 can comprise application(s) 110, a routing component 112, a model component 114, and/or a parallel processing component 116.

In some examples, the core network(s) 106 can include various computing device(s) 118 comprising model(s) 120 and a parallel processing component 122. In some examples, the data network(s) 108 can include various computing device(s) 124 comprising model(s) 126 and a parallel processing component 128.

In some examples, a user can use the UE 102 to input data or a prompt to an application 110. In some examples, the application 110 can be a browser application or a particular application providing an interface to the routing component 112. By way of example, and without limitation, the user of the UE 102 can provide an input to the application 110 that asks for an answer to a particular question, such as “how do I do a backflip?”, an input that requests the performance of a particular task or a series of tasks, an input that requests the processing of specific data or sets of data to generate output data, and/or so forth. The application 110 can provide the input to the routing component 112, which can receive the input and determine which location/model to route the input for receiving a response.

In some examples, the input can explicitly or implicitly include personal data to personalize the input and the subsequent response. In the context of the example above (e.g., “how do I do a backflip?”) the application 110 and/or the routing component 112 can add personal information such as height data, weight data, gender data, general fitness level, and the like. In some examples, such additional data can be referred to as personalized data.

In some examples, the routing component 112 can include rules or heuristics for routing the input. For example, if a network connection to the base station 104 is not available, the routing component 112 can determine to route the input to the model component 114 of the UE 102. In addition or in the alternative, the routing component 112 can comprise a machine learned model that can classify the input and/or determine a probability that respective locations (e.g., of the available models 114, 120, and/or 126) are the correct location for sending an input. In some examples, the routing component 112 can be trained to determine a location to send an input, with supervised or unsupervised training providing ground truth as a “correct” location to send an input. Of course, other training techniques are contemplated here.

In some examples, the routing component 112 can include one or more machine learned models. For example, the routing component 112 can include one or more neural networks, convolutional neural networks (CNN), graph neural networks (GNN), large language models (LLM), and the like. In some examples, the routing component 112 (and/or any of the components discussed herein) can use retrieval-augmented generation (RAG) to augment input to the model(s) and/or to augment the responses received from such models.

By way of example, the routing component 112 can receive an input (e.g., “how do I do a backflip?”) and can determine a classification probability that a particular destination is a correct destination to send the input. In other words, the routing component can receive an input and can output a probability associated with each destination that the particular destination is the correct destination to send the input. Further, the routing component 112 can determine which location is associated with the highest probability and the routing component 112 can select or otherwise determine the location (destination) based on the probability associated with that location. Additional examples are contemplated within this disclosure and are discussed herein.

If the routing component 112 determines to route an input to the model component 114, the routing component 112 can send the input to the model component 114. The model component 114 can execute the model on the parallel processing component 116, which can return a result to the routing component 112 and/or the application 110 for presentation on the UE 102 (or on a device associated with the UE 102).

In some examples, the routing component 112 can route an input to the model(s) 120 and/or the model(s) 126 hosted in the core network(s) 106 and/or the data network(s) 108, respectively. If the model(s) 120 receives the input from the routing component 112, the model(s) 120 can execute on the parallel processing component 122 and can return a result to the routing component 112 and/or the application(s) 110. If the model(s) 126 receives the input from the routing component 112, the model(s) 126 can execute on the parallel processing component 128 and can return a result to the routing component 112 and/or the application(s) 110.

Continuing with the input example introduced above (e.g., “how do I do a backflip?”), the selected model can return any combination of text, image(s), video, and/or audio in response to the input. For example, the response may be a set of instruction explaining how to successively build up steps to perform a backflip.

In some examples, the UE 102 can comprise any of various types of wireless cellular communication devices that are capable of wireless data and/or voice communications, including smartphones and other mobile devices, “Internet-of-Things” (IoT) devices, smart home devices, computers, wearable devices, entertainment devices, industrial control equipment, etc. Further examples can include, but are not limited to, smart phones, mobile phones, cell phones, tablet computers, portable computers, laptop computers, personal digital assistants (PDAs), electronic book devices, or any other portable electronic devices that can generate, request, receive, transmit, or exchange voice, video, and/or digital data over a network. Additional examples of UEs include, but are not limited to, smart devices such as televisions, refrigerators, washing machines, dryers, smart mirrors, coffee machines, lights, lamps, temperature sensors, leak sensors, water sensors, electricity meters, parking sensors, music players, headphones, or any other electronic appliances that can generate, request, receive, transmit, or exchange voice, video, and/or digital data over a network.

In general, the UE 102 can include any device that is capable of transmitting/receiving data wirelessly using any suitable wireless communications/data technology, protocol, or standard, such as Global System for Mobile communications (GSM), Time Division Multiple Access (TDMA), Universal Mobile Telecommunications System (UMTS), Evolution-Data Optimized (EVDO), Long Term Evolution (LTE), Advanced LTE (LTE+), New Radio (NR), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VoIP), VOLTE, Institute of Electrical and Electronics Engineers' (IEEE) 802.1x protocols, WiMAX, Wi-Fi, Data Over Cable Service Interface Specification (DOCSIS), digital subscriber line (DSL), CBRS, and/or any future Internet Protocol (IP)-based network technology or evolution of an existing IP-based network technology. The UE 102 can implement enhanced Mobile Broadband (eMBB) communications, Ultra Reliable Low Latency Communications (URLLCs), massive Machine Type Communications (mMTCs), and the like. In some examples, the UE 102 can communicate via any terrestrial (e.g., ground-based) and/or non-terrestrial (e.g., satellite) base stations.

In some examples, the base station 104 can comprise one or more of an eNodeB (eNB), a gNodeB (gNB), and the like. In some examples, the base station 104 can be any device that is capable of transmitting/receiving data wirelessly using any suitable wireless communications/data technology, protocol, or standard, such as Global System for Mobile communications (GSM), Time Division Multiple Access (TDMA), Universal Mobile Telecommunications System (UMTS), Evolution-Data Optimized (EVDO), Long Term Evolution (LTE), Advanced LTE (LTE+), New Radio (NR), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VoIP), VOLTE, Institute of Electrical and Electronics Engineers' (IEEE) 802.1x protocols, WiMAX, Wi-Fi, Data Over Cable Service Interface Specification (DOCSIS), digital subscriber line (DSL), CBRS, and/or any future Internet Protocol (IP)-based network technology or evolution of an existing IP-based network technology. The base station 104 can implement enhanced Mobile Broadband (eMBB) communications, Ultra Reliable Low Latency Communications (URLLCs), massive Machine Type Communications (mMTCs), and the like. In some examples, the base station 104 can be any terrestrial (e.g., ground-based) and/or non-terrestrial (e.g., satellite) base station.

In some examples, the base station 104 can utilize a 4G radio technology. The base station 104 may transmit and receive data via a connection (e.g., at least one LTE radio link) that is defined according to frequency bands included in, but not limited to, a range of 450 MHz to 5.9 GHZ. In some instances, the frequency bands utilized for the base station 104 can include, but are not limited to, LTE Band 1 (e.g., 2100 MHZ), LTE Band 2 (1900 MHZ), LTE Band 3 (1800 MHZ), LTE Band 4 (1700 MHZ), LTE Band 5 (850 MHz), LTE Band 7 (2600 MHZ), LTE Band 8 (900 MHZ), LTE Band 20 (800 MHz GHz), LTE Band 28 (700 MHz), LTE Band 38 (2600 MHZ), LTE Band 41 (2500 MHZ), LTE band 48 (e.g., 3500 MHZ (the CBRS band)), LTE Band 50 (1500 MHz), LTE Band 51 (1500 MHZ), LTE Band 66 (1700 MHZ), LTE Band 70 (2000 MHz), LTE Band 71 (e.g., a 600 MHz band), LTE Band 74 (1500 MHZ), and the like. In some examples, the base station 104 can be, or at least include, an eNodeB.

In some instances, the base station 104 can also utilize a 5G radio technology, such as technology specified in the 5G NR standard, as defined by 3GPP. In certain implementations, the base station 104 can transmit and receive communications with devices over a connection (e.g., at least one NR radio link) that is defined according to frequency resources including but not limited to 5G Band 1 (e.g., 2080 MHz), 5G Band 2 (1900 MHZ), 5G Band 3 (1800 MHZ), 5G Band 4 (1700 MHz), 5G Band 5 (850 MHz), 5G Band 7 (2600 MHZ), 5G Band 8 (900 MHz), 5G Band 20 (800 MHZ), 5G Band 28 (700 MHZ), 5G Band 38 (2600 MHZ), 5G Band 41 (2500 MHZ), NR Band 48 (e.g., 3500 MHZ (the CBRS band)), 5G Band 50 (1500 MHz), 5G Band 51 (1500 MHz), 5G Band 66 (1700 MHZ), 5G Band 70 (2000 MHZ), 5G Band 71 (e.g., a 600 MHz band), 5G Band 74 (1500 MHZ), 5G Band 257 (28 GHZ), 5G Band 258 (24 GHz), 5G Band 260 (39 GHz), 5G Band 261 (28 GHz), and the like. In some examples, the base station 104 can be, or at least include, a gNodeB.

FIG. 1 also shows a single UE 102 (also referred to as a cellular communication device 102 or a device 102), which may be one of many such devices that are configured for use with the techniques discussed herein. In the described example, the UE 102 supports both 4G/LTE and 5G/NR networks and communications. Further, in the described examples, the UE 102 supports both terrestrial networks and non-terrestrial networks.

In some examples, the core network(s) 106 can include a 4G core network and/or a 5G core network.

In some examples, the core network 106 can include 4G core network comprising a Mobility Management Entity (MME), a Serving Gateway (SGW), a Packet Data Network (PDN) Gateway (PGW), a Home Subscriber Server (HSS), an Access Network Discovery and Selection Function (ANDSF), an evolved Packet Data Gateway (ePDG), and the like.

In some examples, the core network 106 can include a 5G core network comprising any of an Access and Mobility Management Function (AMF), a Session Management Function (SMF), a Policy Control Function (PCF), an Application Function (AF), an Authentication Server Function (AUSF), a Network Slice Selection Function (NSSF), a Unified Data Management (UDM), a Network Exposure Function (NEF), a Network Repository Function (NRF), a User Plane Function (UPF), and the like.

In some examples, the data networks(s) 108 can comprise an open network, such as the internet.

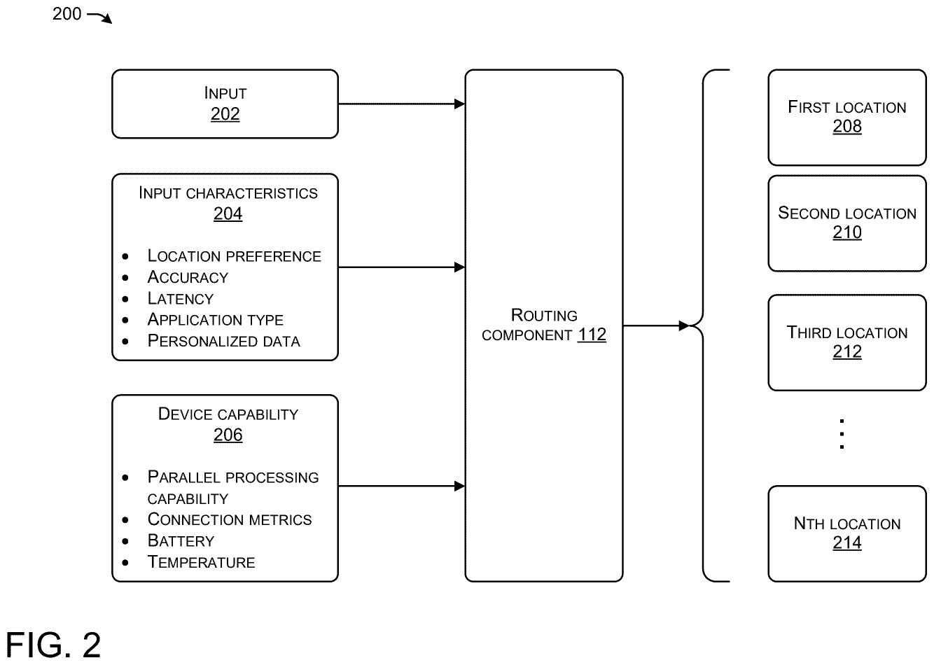

FIG. 2 is a block diagram 200 of a routing component configured to route an input to various locations based on input characteristics and device capabilities.

As illustrated, the routing component 112 can receive an input 202, input characteristics 204 data, and/or device capability 206 data. The routing component 112 can determine a location to send the input 202 and can send the input 202 to one or more of a first location 208, a second location 210, a third location 212, and/or an Nth location 214.

In some examples, the first location 208 can correspond to the UE 102 and the model 114, the second location 210 can correspond to the computing device 118 and the models 120, and the third location 212 can correspond to the computing devices 124 and the model 126. In some examples, the Nth location 214 can correspond to any other UE, any other node in a core network (e.g., the core network 106), or any other node outside of the core network (e.g., outside of the core network 106 and in the data network 108, for example).

As noted above, in some examples, the input 202 can include one or more of text, image, video, audio, gesture, and the like. In some examples, the input can represent one our more outputs from other models or applications, such as a fitness application or personal data tracker (e.g., tracking heart rate, step/distance, VO2 max, and the like).

In some examples, the input characteristics 204 can include, but are not limited to, one or more of a location preference (e.g., a preference where to send an input, such as the first location 208, the second location 210, the third location 212, the Nth location 214, and the like), an accuracy metric (e.g., whether accuracy of the model is preferred or is a priority), a latency metric (e.g., whether a prompt response is preferred over a delay in waiting for a response, whether to stream a response or whether to present a response when an entire response is received, and the like), and an application type (e.g., indicative of which application was used to generate an input, such as a specific application downloaded by or installed by a used, whether an application native to the UE 102 was used, and the like). In some examples, the input characteristics may comprise more or fewer attributes or characteristics, as discussed herein.

In some examples, the device capability 206 can include, but is not limited to, one or more of a parallel processing capability (e.g., indicative of whether the UE includes a parallel processor and the capabilities (e.g., number of cores, memory, and the like)), connection metrics (e.g., whether the UE 102 is connected to the base station 104, a type of connection (e.g., terrestrial, non-terrestrial, 4G, 5G, dual connectivity, carrier aggregation, Wi-Fi, etc.), a bandwidth of the connection, a latency of the connection, a ping or delay, uplink and/or downlink speed, jitter, SINR, and the like), battery status (e.g., whether the UE 102 is connected to external power, whether the battery is charging, a charge percentage of the battery, and the like), and/or temperature status (e.g., a temperature of the UE, a temperature of the processor, whether the processor(s) are overheating), and the like. In some examples, the device capabilities 206 may comprise more or fewer attributes or characteristics, as discussed herein.

The routing component 112 can receive the input 202 to route the input to one or more locations (e.g., 208, 210, 212, and/or 214). In some examples, the routing component 112 can receive the input characteristics 204 and/or the device capability 206. In response to receiving the input 202, the input characteristics 204, and/or the device capability 206, the routing component 112 can determine to route the input (or data based on the input) to one or more of the first location 208, the second location 210, the third location 212, and/or the Nth location 214.

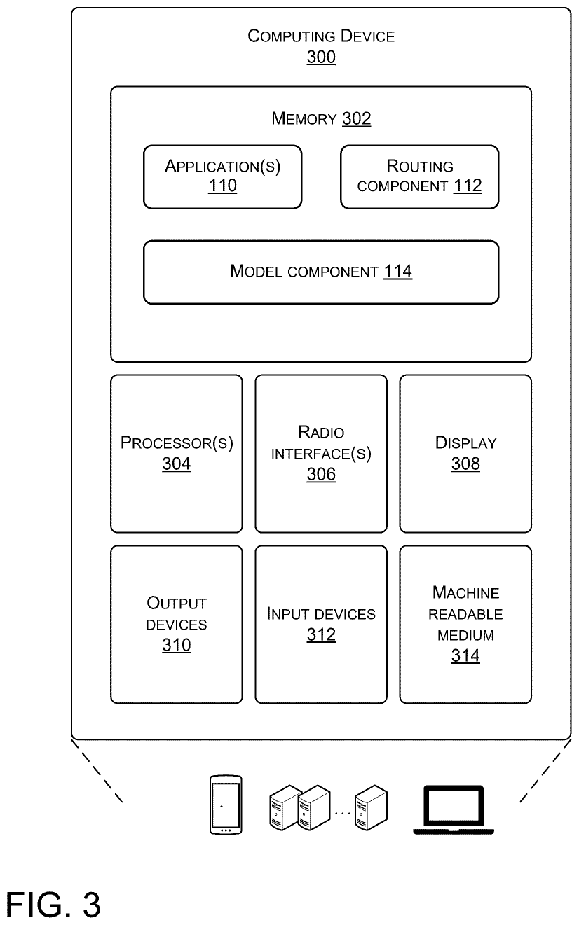

FIG. 3 illustrates an example computing device 300 to implement the routing component for routing inputs to machine learned model(s), as discussed herein. In some examples, the computing device 300 can correspond to the UE 102 of FIG. 1. It is to be understood in the context of this disclosure that the computing device 300 can be implemented as a single device, as a plurality of devices, or as a system with components and data distributed among them.

As illustrated, the computing device 300 comprises a memory 302 storing the application(s) 110, the routing component 112, and/or the model component 114. Also, the computing device 300 includes processor(s) 304 (which may include the parallel processing component 116), radio interface(s) 306, a display 308, output devices 310, input devices 312, and a machine readable medium 314.

In various implementations, the memory 302 is volatile (such as RAM), non-volatile (such as ROM, flash memory, etc.) or some combination of the two. The application(s) 110, the routing component 112, and/or the model component 114 stored in the memory 302 can comprise methods, threads, processes, applications or any other sort of executable instructions. The application(s) 110, the routing component 112, and/or the model component 114 can also include files and databases.

In general, the application(s) 110 can include functionality to receive input from a user to provide to a machine learned model, such as a generative model. In some examples, the application can be an application native to the computing device 300, such as a text input, a browser, or image sensor. In some examples, the application 110 can be a special purpose application downloaded and/or installed by the user, and specific to a particular model. In some examples, the application(s) 110 can receive as input, one or more of text data, image data, video, audio data, gesture, or other data, as discussed herein.

In general, the routing component 112 can include functionality to receive input from the application(s) 110 and/or characteristics of the input (e.g., associated with preferences or settings provided by or set in the application(s) 110). In some examples, the routing component 112 can also receive and/or determine device capability information, such as a status and/or availability of one or more parallel processors of the processor(s) 304, a connection status, etc. The routing component 112 can receive and/or determine the input, the characteristics of the input, and/or the device capability information and can output one or more locations to send the input to be input to a machine learned model.

In general, the model component 114 can include functionality to receive the input and to generate a response to the input. In some examples, the model component 114 can be a generative machine learned model, such as one provided by OpenAI (e.g., Chat GPT), Stable Diffusion, Dall-E, and the like. In some examples, the model component 114 can generate text, image(s), video, audio, gestures, or other information in response to the input, as discussed herein.

In various examples, the processor(s) 304 can be a central processing unit (CPU), a graphics processing unit (GPU) (e.g., such as the parallel processing component 116), or both CPU and GPU, or any other type of processing unit. Each of the one or more processor(s) 304 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 304 may also be responsible for executing all computer applications stored in the memory 302, which can be associated with common types of volatile (RAM) and/or nonvolatile (ROM) memory.

As noted above, in some examples, the processor(s) 304 can include, but are not limited to, a graphics processing unit (GPU), an Artificial Intelligence (AI) accelerator, a deep learning processor, a neural processing unit (NPU), and the like.

The radio interfaces 306 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the radio interfaces 306 can be compatible with multiple radio access technologies, such as 5G radio access technologies and 4G/LTE radio access technologies. Accordingly, the radio interfaces 306 can allow the computing device 300 to connect to various components as described herein.

The display 308 can be a liquid crystal display or any other type of display commonly used in computing devices. For example, display 308 may be a touch-sensitive display screen, and can then also act as an input device or keypad, such as for providing a soft-key keyboard, navigation buttons, or any other type of input. The output devices 310 can include any sort of output devices known in the art, such as the display 308, speakers, a vibrating mechanism, and/or a tactile feedback mechanism. Output devices 310 can also include ports for one or more peripheral devices, such as headphones, peripheral speakers, and/or a peripheral display. The input devices 312 can include any sort of input devices known in the art. For example, input devices 312 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 314 can store one or more sets of instructions, such as software or firmware, that embodies any one or more of the methodologies or functions described herein. The instructions can also reside, completely or at least partially, within the memory 302, processor(s) 304, and/or radio interface(s) 306 during execution thereof by the computing device 300. The memory 302 and the processor(s) 304 also can constitute machine readable media 314.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

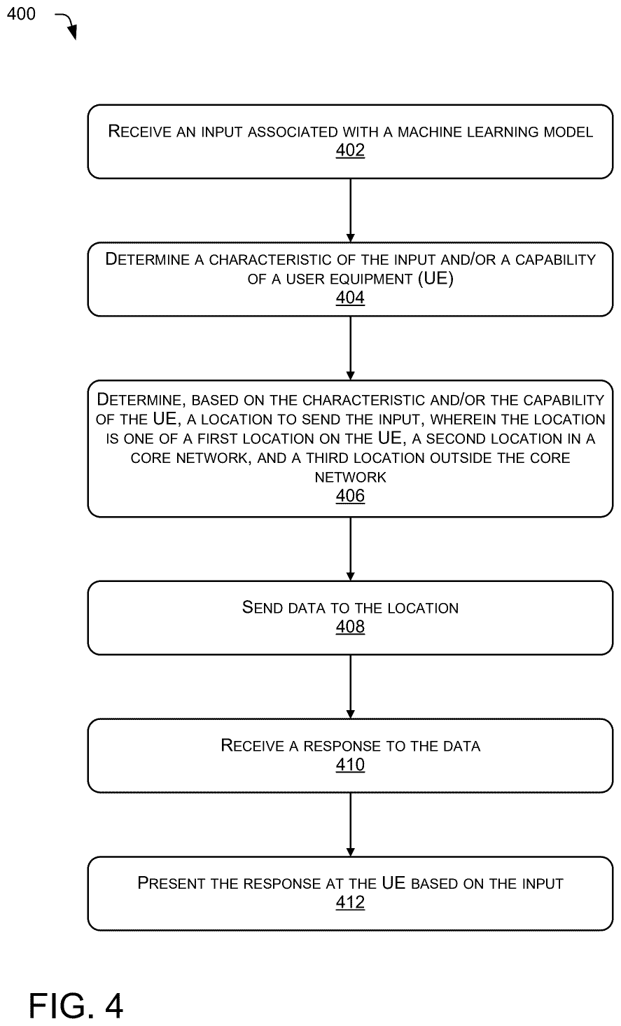

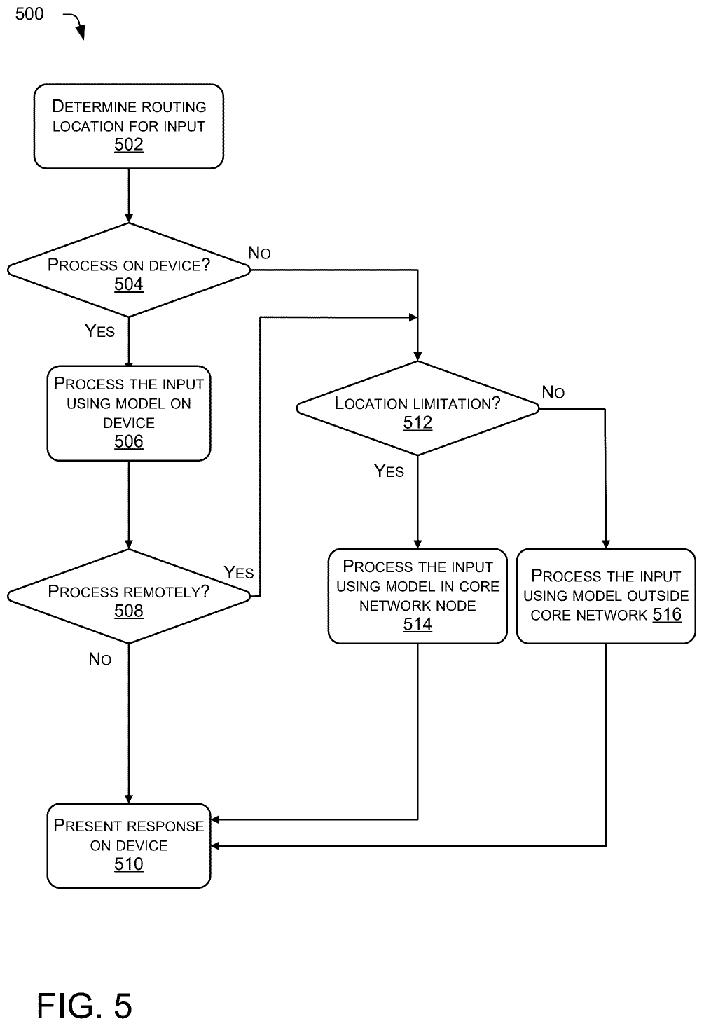

FIGS. 4 and 5 illustrate example processes in accordance with examples of the disclosure. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

FIG. 4 illustrates an example process for routing an input to various machine learned models implemented at different locations. The example process 400 can be performed by the routing component 112 (and/or another component), in connection with other components and/or devices discussed herein. Some or all of the process 400 can be performed by one or more devices or components in the environment 100, for example.

At operation 402, the process can include receiving an input associated with a machine learned model. As discussed herein, the input can include one or more of textual input, image input, video input, audio input, gesture input, and/or other input from other sensors (e.g., a health or fitness tracker, a security camera), other applications, and the like.

At operation 404, the process can include determining a characteristic of the input and/or a capability of a user equipment (UE). In some examples, the characteristics of the input can include, but are not limited to, one or more of a location preference, a privacy metric, an accuracy metric, an application type, and/or a latency metric. In some examples, characteristics and/or capabilities of the UE can include, but are not limited to, one or more of an indication or whether the UE includes a parallel processing unit (e.g., a graphics processing unit (GPU)) configured to host a machine learned model. Additionally or in the alternative, the operation 404 can include determining connection metrics such as the type of connection (e.g., between a UE and a base station, such as Wi-Fi, 4G, 5G, etc.), bandwidth, latency, etc.

In some examples, the operation 404 can also include receiving load information from one or more locations that the routing component 112 is configured to send input data. For example, the operation 404 can include receiving load information associated with the first location 208, the second location 210, the third location 212, and/or the Nth location 214. In some examples, the load information can further indicate a state of readiness or a state of a queue associated with each location, or an estimated wait time if a request were to be submitted.

At operation 406, the process can include determining, based on the characteristic and/or the capability of the UE, a location to send the input, wherein the location is one of a first location on the UE, a second location in a core network, and a third location outside the core network. As discussed herein, in some examples the operation 406 can include applying one or more rules, heuristics, or machine learned models to the input and other characteristics to determine the location to send the input. In some examples, the operation 406 can include optimizing the location based on the date input to the routing component 112.

At operation 408, the process can include sending data to the location. In some examples, the operation 408 can include transmitting data wirelessly to a core network and/or a data network determined by the routing component 112.

At operation 410, the process can include receiving a response to the data.

At operation 412, the process can include presenting the response that is at least based on the input at the UE. In some examples, the operation 412 can include presenting text, images, video, audio, haptic feedback, and the like. In some examples, the operation 412 can include alternatively or concurrently sending the response to another application, datastore, or device associated with the UE.

FIG. 5 illustrates an example process for routing an input to various machine learned models in parallel, as discussed herein. The example process 500 can be performed by the routing component 112 (and/or another component), in connection with other components and/or devices discussed herein. Some or all of the process 500 can be performed by one or more devices or components in the environment 100, for example.

At operation 502, the process can include determining a routing location for an input. In some examples, the operation 502 can include receiving an input at a UE (e.g., the UE 102) and sending the input to a routing component (e.g., the routing component 112) along with characteristics of the input and/or the device capability to determine a location to send the input.

At operation 504, the process can include determining whether to process the input on device (e.g., on the UE 102). If the input is to be processed on device (e.g., “yes” in operation 504) the process continues to operation 506.

At operation 506, the process can include processing the input using a model on the device. In some examples, the operation 506 can include inputting the input to a generative machine learned model to operate on a GPU of the device.

At operation 508, the process can include determine whether to process the input remotely (e.g., in addition to processing the input on the device). If the input is not to be processed remotely (e.g., “no” in operation 508) the process continues to operation 510.

At operation 510, the process can include presenting the response on device. In some examples, the operation 510 can include presenting text, images, video, audio, haptic feedback, and the like. In some examples, the operation 510 can alternatively or concurrently include sending the response to another application, datastore, or device associated with the UE.

Returning to the operation 504, if the input is not to be processed on device (e.g., “no” in operation 504) the process continues to operation 512.

At operation 512, the process can include determining whether the input is associated with a location limitation. If there is a location limitation associated with the input (e.g., “yes” in operation 512), the process continue to operation 514.

At operation 514, the process can include processing the input using a model in a core network node (e.g., in the core network 106). After the input is processed in the core network node, the response is returned to the UE and the response is presented on the device in operation 510.

If there is no location limitation (e.g., “no” in operation 512) the process may continue to operation 516.

At operation 516, the process can include processing the input using a model outside the core network. After the input is processed outside the core network node, the response can be returned to the UE and the response can be presented on the device in operation 510.

Returning to the operation 508, after the input is processed by the model on the device, the input can be processed remotely as well (e.g., “yes” in operation 508. Accordingly the process can continue to the operation 512, such that the input can be processed on device and by a model remote to the device (e.g., in the core network or outside the core network) as well. In such an example (when input is processed in a plurality of locations simultaneously or substantially simultaneously or in parallel), the operation 510 can include presenting the multiple responses on the UE (e.g., individually, aggregating, combining the response, generating an updated response, and the like).

Accordingly the techniques discussed herein describe routing inputs to various models to efficiently generate response to user input based on characteristics of the input and/or based on device capabilities.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A user equipment comprising:
one or more processors; and
one or more non-transitory computer readable media storing computer executable instructions that, when executed, cause the one or more processors to perform operations comprising:
receiving, at the user equipment (UE), an input associated with a generative machine learned model;
determining a characteristic of the input;
determining a capability of the UE;
determining, based on the characteristic of the input and the capability of the UE, a location to send the input, wherein the location is one of a plurality of locations, wherein the plurality of locations comprises at least a first location associated with a parallel processing unit associated with the UE, a second location associated with a first network node in a core network, and a third location associated with a second network node outside the core network;
sending, based at least in part on the input, data to the location;
receiving, at least partially in response to the data, a response from an instance of the generative machine learned model associated with the location; and
presenting the response at the UE.

2. The user equipment of claim 1, wherein the characteristic of the input comprises at least one of:
a location preference;
a privacy metric;
an accuracy metric;
an application type;
a latency metric; or
personalized data.

3. The user equipment of claim 1, wherein the capability of the UE indicates whether the UE includes a parallel processing unit configured to host the generative machine learned model.

4. The user equipment of claim 1, wherein:
the UE is associated with a user profile provided by a wireless communication provider; and
the second location is associated with a private network hosted by the wireless communication provider.

5. The user equipment of claim 1, wherein determining the location to send the input is performed by a machine learned model executing on the UE.

6. The user equipment of claim 1, the operations further comprising;
sending the input to the first location;
receiving, as a first response, the response from a generative machine learned model executing on the UE;
sending the input to at least one of the second location or the third location;
updating, as an updated response, the first response based at least in part on a second response from the at least one of the second location or the third location; and
presenting the updated response on the UE.

7. The user equipment of claim 1, the operations further comprising:
sending the input to the second location with an instruction to restrict further sending the input to the third location or another location outside of the core network.

8. The user equipment of claim 1, wherein:
the first location is associated with a first instance of the generative machine learned model;
the second location is associated with a second instance of the generative machine learned model;
the third location is associated with a third instance of the generative machine learned model; and
the first instance, the second instance, and the third instance are different versions of the generative machine learned model.

9. A computer-implemented method comprising:
receiving, at a user equipment (UE), an input associated with a generative machine learned model;
determining a characteristic of the input;
determining a capability of the UE;
determining, based on the characteristic of the input and the capability of the UE, a location to send the input, wherein the location is one of a plurality of locations, wherein the plurality of locations comprises at least a first location associated with a parallel processing unit associated with the UE, a second location associated with a first network node within a core network, and a third location associated with a second network node outside the core network;
sending, based at least in part on the input, data to the location;
receiving, at least partially in response to the data, a response from an instance of the generative machine learned model associated with the location; and
presenting the response at the UE.

10. The computer-implemented method of claim 9, wherein the characteristic of the input comprises at least one of:
a location preference;
a privacy metric;
an accuracy metric;
an application type;
a latency metric; or
personalized data.

11. The computer-implemented method of claim 9, wherein the capability of the UE indicates whether the UE includes a parallel processing unit configured to host the generative machine learned model.

12. The computer-implemented method of claim 9, wherein:
the UE is associated with a user profile provided by a wireless communication provider; and
the second location is associated with a private network hosted by the wireless communication provider.

13. The computer-implemented method of claim 9, wherein determining the location to send the input is performed by a machine learned model executing on the UE.

14. The computer-implemented method of claim 9, further comprising;
sending the input to the first location;
receiving, as a first response, the response from a generative machine learned model executing on the UE;
sending the input to at least one of the second location or the third location;
updating, as an updated response, the first response based at least in part on a second response from the at least one of the second location or the third location; and
presenting the updated response on the UE.

15. The computer-implemented method of claim 9, further comprising:
sending the input to the second location with an instruction to restrict further sending the input to the third location or another location outside of the core network.

16. One or more non-transitory computer-readable media storing computer executable instructions that, when executed, cause one or more processors to perform operations comprising:
receiving, at a user equipment (UE), an input associated with a generative machine learned model;
determining a characteristic of the input;
determining a capability of the UE;
determining, based on the characteristic of the input and the capability of the UE, a location to send the input, wherein the location is one of a plurality of locations, wherein the plurality of locations comprises at least a first location associated with a parallel processing unit associated with the UE, a second location associated with a first network node, and a third location associated with a second network node outside a core network;
sending, based at least in part on the input, data to the location;
receiving, at least partially in response to the data, a response from an instance of the generative machine learned model associated with the location; and
presenting the response at the UE.

17. The one or more non-transitory computer-readable media of claim 16, wherein the characteristic of the input comprises at least one of:
a location preference;
a privacy metric;
an accuracy metric;
an application type;
a latency metric; or
personalized data.

18. The one or more non-transitory computer-readable media of claim 16, wherein the capability of the UE indicates whether the UE includes a parallel processing unit configured to host the generative machine learned model.

19. The one or more non-transitory computer-readable media of claim 16, wherein:
the UE is associated with a user profile provided by a wireless communication provider; and
the second location is associated with a private network hosted by the wireless communication provider.

20. The one or more non-transitory computer-readable media of claim 16, wherein determining the location to send the input is performed by a machine learned model executing on the user equipment.
